(19) United States
(12) Patent Application Publication
(10) Pub. No.: US 2004/0152599 A1
(43) Pub. Date: Aug. 5, 2004

(54) High-temperature superconductivity devices and methods

(76) Inventor: Allan Rosencwaig, Danville, CA (US)

Correspondence Address: Martin C. Fliesler, FLIESLER DUBB MEYER & LOVEJOY LLP, Fourth Floor, Four Embarcadero Center, San Francisco, CA, 94111-4156, US

(21) Appl. No.: 10/713,459

(22) Filed: Nov. 14, 2003

Related U.S. Application Data
(60) Provisional application No. 60/428,106, filed on Nov. 21, 2002.

(51) Int. Cl. H01B 1/00

(52) U.S. Cl. 505/100

(57) ABSTRACT

A singlet bonding state may arise from the hybridization of molecular orbitals in a cluster containing several atoms in a material. This singlet state can move about the lattice as a bosonic preformed pair with low binding energy that is spatially bounded, has short range attractive interaction with other preformed pairs, and that can undergo Bose-Einstein condensation.

### PRIORITY CLAIM

The present invention claims priority under 35 U.S.C. 119(e) from U.S. Provisional Application No. 60/428,106, filed on Nov. 21, 2002, entitled: High-Temperature Superconductivity Devices and Methods, Inventor: Allan Rosencwaig, the contents of which are incorporated herein by reference.

### TECHNICAL FIELD

The invention relates to high temperature superconductors, superconductor devices, and methods of making such superconductors.

### BACKGROUND

There has been a great deal of research in the field of high-temperature superconductivity since the discovery of high-temperature superconducting cuprates in 1986. The wealth of experimental data accumulated since then has provided a well documented catalog of the principal characteristics of these new materials. The theoretical effort has not been as successful, as many theories have been tried but an understanding of high-temperature superconductivity remains elusive.

The great interest in these materials is understandable, since the transition temperature (T_{c}) is typically about 100 K, or roughly ten times higher than in conventional superconductors. While there has been much effort to develop high-temperature superconductors, the lack of an appropriate model has been detrimental to these efforts. To date, the highest reproducible values of T_{c} appear to be about 135 K, considerably below room temperature or 300 K. Nevertheless, this has given rise to the hope that even higher temperature superconductors, perhaps even those that could operate at room temperature, might be possible. The development of room temperature superconductors would have a profound effect on many areas of commerce, technology, and science. Major advances would be possible in electrical power generation and transmission, electric motors, power conditioning and energy storage, microelectronics, telecommunications, transportation, medical devices and imaging systems, and scientific instrumentation. In brief, the advent of room temperature superconductors would be revolutionary.

### BRIEF SUMMARY

Systems, methods, and compounds in accordance with the present invention provide for high-temperature superconductivity. In selected materials, a singlet electronic state can form a preformed charge pair with low binding energy that is spatially bounded and has a short-range attractive interaction with other preformed pairs. This pair can undergo Bose-Einstein condensation (BEC) and exhibit superconductivity at temperatures considerably above the temperatures of Bardeen-Cooper-Schrieffer (BCS) superconducting materials.

### BRIEF DESCRIPTION OF THE DRAWINGS

FIG. 1 illustrates a section of the square-planar Cu—O plane showing a central Cu atom, A, the 4 B nearest neighbors and the 4 C next-nearest neighbors, together with the in between O atoms.

FIG. 2 illustrates a larger section of the Cu—O plane and includes the 4 D third-nearest neighbors.

FIG. 3 illustrates a simplified energy level diagram for the 13 dopant cluster orbitals formed from the hybridization of the 13 σ*ₓ²_{y}² molecular orbitals in the (Cu)₁₃ cluster.

FIG. 4 is a graph illustrating the transition temperature, T_{c}, vs the dopant charge per in-plane Cu, q, for the two superconducting cuprates La₂₋ₓSrₓCuO₄ (LSCO) and Nd₂₋ₓCeₓCuO₄ (NCCO).

FIG. 5 is a graph illustrating the transition temperature, T_{c}^{m}, vs the dopant charge per in-plane Cu, q, for the superconducting cuprate Bi₂Sr₂CaCu₂O_{8-y} (Bi2212).

FIG. 6 is a graph illustrating the maximum transition temperature, T_{c}^{m}, with z=P(δₘ,T_{c}^{m}) for various values of δₘ.

FIG. 7 is a graph illustrating the maximum transition temperature, T_{c}^{m}, with charge density, nₑ for various values of δₘ.

### DETAILED DESCRIPTION

Devices and methods in accordance with one embodiment of the present invention take advantage of a high-temperature superconductivity model referred to herein as the (Cu)₁₃-BEC model, or the “Model”. This Model is discussed in a paper entitled “A Bose-Einstein Condensation Model for High-Temperature Superconductivity” by A. Rosencwaig, Physical Review B 67, 184514 (2003) which is incorporated herein by reference. This Model is able to account, in a quantitative and natural way, for many of the characteristics of room temperature superconductors. In this Model, a singlet state for the mobile dopant charges arises from the hybridization of molecular orbitals in a cluster containing thirteen Cu atoms in a Cu—O plane of the cuprate compounds. While the present model relies upon cuprates for illustrative purposes, it is inclusive of other materials such as other oxides, ceramics, poor metals, intermetallic compounds, doped insulators or semiconductors

Superconductivity in the cuprates is intimately related to the presence of dopant charge (electrons or holes) in the Cu—O planes or layers. While cuprates are used for illustrative purposes herein the present invention is not limited to cuprates and can be directed towards enabling superconductivity in any number of substances. In the present embodiment a Cu atom in a Cu—O plane is covalently bonded to other atoms in the plane, and the highest filled molecular orbital of this (CuO₄)⁻⁶ cluster is the anti-bonding σ*ₓ²_{-y}²=dₓ²_{-y}²±pσₓ±pσ_{y} orbital. In the undoped tetragonal cuprates, the crystal field and strong on-site Coulomb correlation splits the half-filled σ*ₓ²_{-y} ² band into an empty Hubbard conduction band primarily of Cu 3 d character and a filled valence band primarily of O 2 p character separated by a charge transfer gap of 1-2 eV.

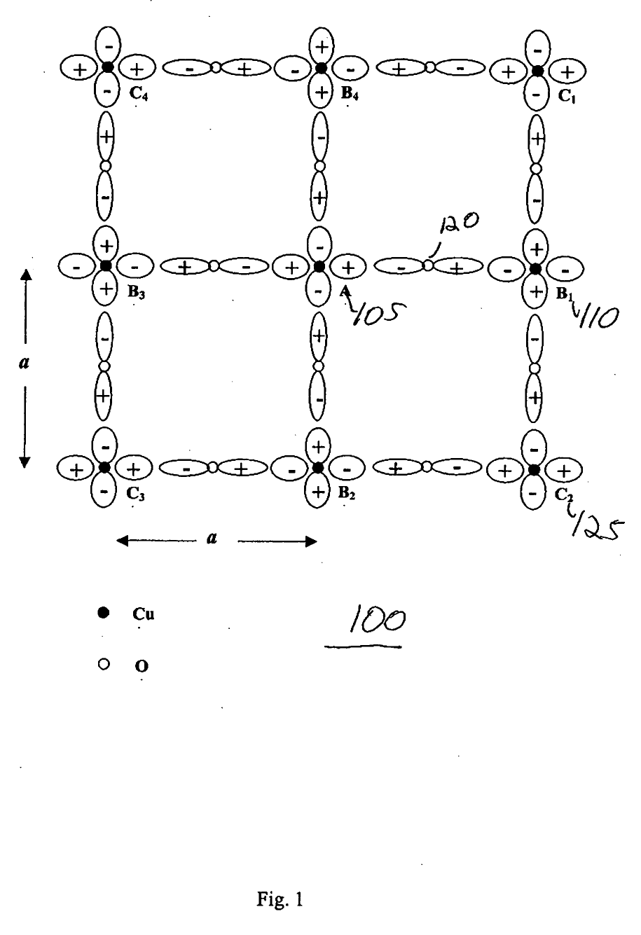

FIG. 1 depicts a central Cu atom, A 105, covalently bonded through O atoms 120 to its 4 nearest Cu neighbors, B₁, B₂, B₃ and B₄ 110 all at a distance a, the lattice constant in the plane. The second-nearest Cu neighbors, C₁, C₂, C₃ and C₄ 125 are all at a distance √2 a. The phases or symmetries of the σ*ₓ²_{-y}² molecular orbitals at the B sites are all identical but opposite to that at site A, while the C site orbitals have the same symmetry as site A.

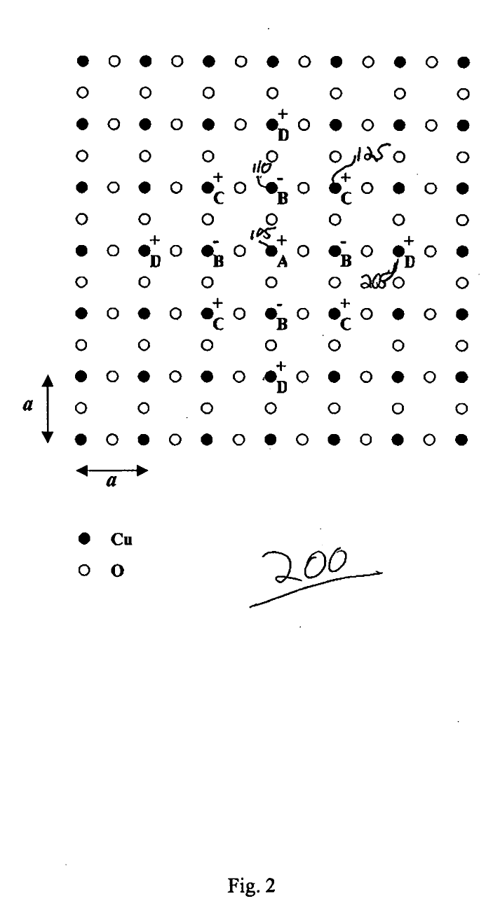

FIG. 2 expands the number of Cu sites displayed, and includes the 4 third-nearest neighbors, D1, D2, D3 and D4 205. Rather than draw all of the anti-bonding orbitals with the symmetry of the orbitals at the various Cu sites, the symmetry is illustrated with a (+) or (−). The present embodiment employs a t-t′-t″-J model which considers direct long-range Cu—Cu hopping between Cu atoms. In determining the site-hopping matrix element, t, for charge hopping between a central Cu site, (A) 105, and nearest-neighbor, (B) 110, next-nearest neighbor, (C) 125, and third-nearest neighbor, (D) 205, Cu sites, it is assumed that distance, orbital orientation and orbital symmetry all play important roles. FIG. 2 illustrates that A-B interactions have favorable distance, a, favorable orbital orientation but unfavorable symmetry, A-C interactions have less favorable distance, √2 a, highly unfavorable orbital orientation (the sites being on a diagonal while the orbitals are aligned along x and y), but favorable symmetry, while the third-nearest neighbor A-D interactions have unfavorable distance, 2 a, but favorable orientation and favorable symmetry. Combining the effects of distance, orbital orientation and symmetry it is reasonable to assume that A-B, A-C, and A-D interactions are all comparable but considerably greater than interactions beyond the D neighbors. Thus the primary dopant charge interaction cluster consists of the central Cu, A, 105 the 4 nearest Cu B 110 neighbors, the 4 second-nearest Cu C 125 neighbors and the 4 third-nearest Cu D 205 neighbors. This then constitutes a fundamental interaction cluster of 13 Cu atoms and 26 O atoms, which is designated as the (CU)₁₃ cluster.

In this t-t′-t″-J model, dopant interactions between the 13 Cu sites in the (Cu)₁₃ cluster can result in a hybridization of the 13 dopant anti-bonding σ*ₓ²_{-y}² molecular orbitals into 13 dopant cluster orbitals, which can be considered to constitute a mini impurity band located near the top of the undoped valence band for p-doping and near the bottom of the undoped conduction band for n-doping. Hybridizing the σ*ₓ²_{-y}² orbitals, includes O 2 p as well as Cu 3 d orbitals in the charge hopping process. Antiferromagnetic exchange interactions between the dopant charge and the valence electron on the Cu sites makes singly-occupied and triplet cluster states more energetic than singlet states because of spin flipping as the charge moves from site to site within the cluster. The singlet states, which need not undergo spin flipping, are thus the lowest energy states.

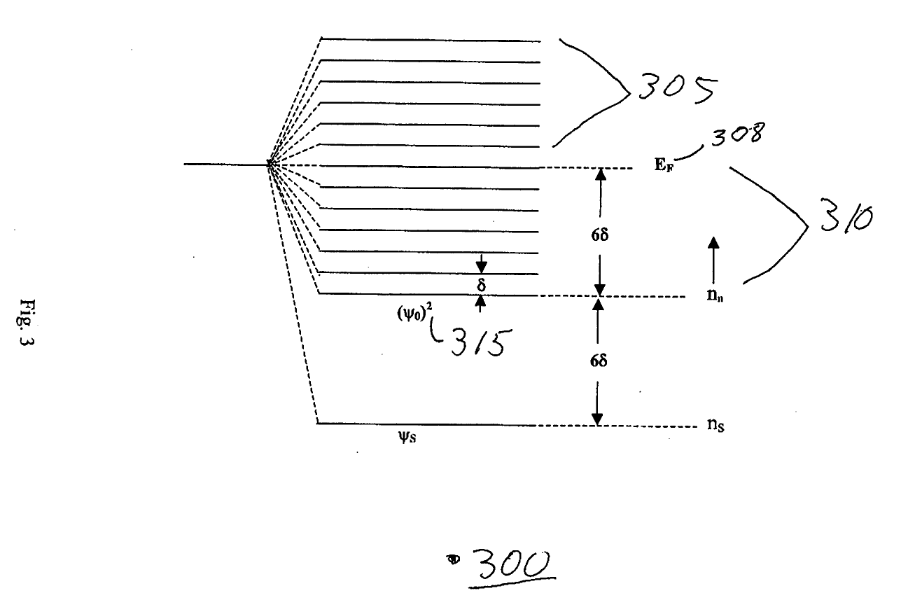

FIG. 3 is an energy diargram for the hybridized states that depicts 13 singlet cluster orbitals as being spread evenly apart by an energy δ, as depicted by the nₙ states. The 6 lower states 310 are bonding states, the center 308 is a non-bonding state and the upper 6 states are anti-bonding states. In the present embodiment, the lowest energy singlet (ψ₀)² state has a primarily dₓ²_{-y}² symmetry since all the constituent σ*ₓ²_{-y}² molecular orbitals have this symmetry component and the pσₓ and pay orbitals average out. The symmetry of the energy gap δ is also dₓ²_{-y}². All six of the bonding singlet states are spatially bounded and thus have a fair amount of phase coherence. However to qualify as bosonic quasiparticles for purposes of superconductivity, a singlet state must retain its coherence during transport, i.e. during the hopping process between clusters. It is assumed for the present embodiment that only the ground (ψ₀)² singlet state retains enough phase coherence during transport to qualify as a bosonic quasiparticle, or preformed pair, that can participate in superconductivity.

The present embodiment differs from previous treatments in several respects. First, the interaction cluster is much larger, consisting of 13 Cu atoms, and includes direct Cu—Cu charge hopping up to third-nearest neighbors. Secondly, when the electrostatic potential from the dopant ions is included in the crystal Hamiltonian, the (ψ₀)² singlet state is spatially bounded to dimensions comparable to the size of the (Cu)₁₃ cluster. Furthermore, the singlet state of a local cluster experiences repulsive Coulomb interaction with another cluster at large separations but experiences an attractive interaction at shorter distances. This attractive interaction is the result of a site-hopping interaction when the outer Cu atoms from two clusters are within a distance 1 apart where a≦l≦2 a. In the present embodiment l≈1.5 a. This then puts the attractive interaction distance between two singlet (ψ₀)² states at d=4 a+l≈5.5 a. As more clusters are added the singlet state is delocalized a little and its wavefunction reaches a diameter d because of the site-hopping interactions between adjacent clusters. However, it still remains spatially bounded and does not broaden out into a wide band.

The singlet (ψ₀)² state is a hole or electron pair and represents a charged bosonic quasiparticle, or preformed pair, with a diameter of ≈5.5 a, or ≈20 A since a in the cuprates is typically ≈3.8-3.9 A. These charge pairs can move through the lattice as preformed pairs. Additionally, these charge pairs have densities that are temperature dependent and have low binding energies and thus are not hard-core bosons. These characteristics of the (ψ₀)² charge pairs may possibly account for the non-Fermi-liquid behavior of the normal (non-superconducting) state of the cuprates. Of most importance, however, these bosonic quasiparticles can, under the right conditions, experience Bose-Einstein condensation and thus generate a superconducting state.

### Bose-Einstein Condensation

The preformed pairs are repulsive at large and moderate distances but see an attractive potential when the separation, r, between two clusters is within the site-hopping interaction distance 5 a≦r≦6 a. As a result of this short-range attractive potential, the preformed pairs tend to form small local groups at low densities, with the number of (Cu)₁₃ clusters in each local group determined by the depth of the local minimum in the interaction potential at 5 a≦r≦6 a. The average distance between (Cu)₁₃ clusters in a local group can be set to r=d=5.5 a. The number of clusters in a local group is determined by the condition that the total Coulomb repulsive interaction of the group should not exceed the total attractive site-hopping interaction. Each local group of preformed pairs may undergo a localized Bose-Einstein condensation. Although the groups are formed in a Cu—O plane, there are also interactions between adjacent planes. This allows for the use of the usual three-dimensional Bose-Einstein condensation condition,

a. n_{bl}λ³=2.612 (1)

where n_{bl} is the boson density within a local group and λ is the de Broglie or thermal wavelength of the bosonic quasiparticle. Equation (1) simply states that BEC occurs in a local group when the thermal wavelength is approximately equal to the average distance, d=5.5 a, between the bosons. Now the thermal wavelength is given by,

b. λ=(2πh²/m*kT)^{1/2} (2)

where h is the Planck constant, k is the Boltzmann constant, m* is the effective mass of the preformed bosonic quasiparticle and T is the temperature. If the net interaction between the preformed pairs in a local group is not too large, then m*≈²mₑ where mₑ is the electron mass. Using Eqns. (1) and (2), it can be shown that a local group can undergo a localized BEC at quite high temperatures, typically above 300K. However, this localized BEC of the small local groups does not lead to a global transition to superconductivity, since the local groups are separated from each other. Furthermore, since each group consists of only a few bosons, there are large fluctuations in the phase coherence.

One significant difference between the present embodiment and the conventional atomic BEC situation is that in atomic BEC, the total number of bosons is fixed. In the case of the present embodiment, the number of bosons is dependent on T, since the total number of bosons, and hence the boson density, depends on the occupation probability of the singlet (ψ₀)² state. This is a major element of the (Cu)₁₃-BEC model. Thus, the number of bosons increases as T decreases. There are multiple ways by which a global transition to superconductivity can occur. One path is for the separated local boson groups to become phase coherent through a condensation of local groups. That is, each local group, once it undergoes a localized BEC, can be treated as a large bosonic quasiparticle. Using Eqns. (1) and (2) with an appropriate temperature-dependent group density, nbg, in Eqn. (1) and the larger effective mass of a group in Eqn. (2), it can readily be shown that the resulting transition temperatures are quite low, typically less than 1K. Another path is to allow the number of local groups to increase, as the temperature decreases and the boson density increases, until the average separation between the outer Cu sites of two adjacent local groups approaches the attractive interaction distance, d. At this point, a phase transition can occur that will result in global phase coherence among the groups, and thus a global Bose-Einstein condensation. The condition for this case is given by,

c. n_{b}d³=2.612 (3)

where n_{b} is now the average boson density in the lattice. Thus global Bose-Einstein condensation can occur when the average distance between the bosonic preformed pairs, n_{b}^{-1/3}, approaches the interaction distance, d.

The boson density, n_{b}, is related to the cluster density, N_{c}, by n_{b}=N_{c}n_{bc} where n_{bc} is the number of bosons per cluster. The primitive tetragonal cell has a volume (a×a×c) A³, where a and c are the tetragonal lattice constants of the primitive unit cell, and since each primitive unit cell contains only one formula unit and only one Cu atom per Cu—O plane, then N_{c}=1/(13 a²c). If q is the average dopant charge per Cu atom in a layer of the cluster, and if there are n Cu—O layers per cluster, then the total charge in the cluster is m=13 nq. The number of bosons in the cluster is then n_{bc}=1/2(13 nq)P(δ,T), where P(δ,T) is the probability that a charge is in the ψ₀ state at temperature T and δ is the energy gap separating the ψ₀ state from the next state. P(δ,T) is then given by,

P(δ,T)=1/[1+e^{-δ/kT}+e^{-δ/kT}+ . . . +e^{-12δ/kT}] (4)

Substituting d=5.5 a in Eqn. (3), it is thus demonstrated that for the basic condition for Bose-Einstein condensation in the cuprates,

13q P(δ,T)=0.408(c/a)/n (5)

Since 13 q P(δ,T) represents the number of charges in the ψ₀ state per Cu—O layer in a cluster, and since there is only one ψ₀ state per Cu—O layer in a single cluster, a second condition is,

13q P(δ,T)≦2 (6)

It has been found that all of the cuprates readily satisfy Eqns. (5) and (6) for all experimental values of a, c, n and q, and do so at very reasonable values of P(δ,T). Thus, it can be demonstrated that for a constant δ, a decreasing P(δ,T) results in an increasing T=T_{c}. Thus T_{c} increases with decreasing (c/a) and increasing n. In addition, T_{c} increases with increasing charge per Cu, q.

In the present embodiment, the superconducting charge pair is simply the (ψ₀)² preformed pair condensed into the superconducting state. The symmetry of the superconducting state will thus be the same as that of the preformed (ψ₀)² state, i.e. dₓ²_{-y}², which is in agreement with experiment. Furthermore, since the interaction distance, d, of the preformed pair is independent of temperature, the correlation length at T=0, ξ₀, is simply =½d=2.75 a≈10 A, also in agreement with experiment. Therefore both the observed symmetry and the correlation length of the superconducting pairs in the cuprates follow naturally from the (Cu)₁₃-BEC model.

T_{c} vs q CURVES

At low values of q, Eqn. (6) is always satisfied, and Eqn. (5) will give the threshold dopant charge concentration per Cu atom at which BEC and thus superconductivity can occur. At the threshold concentration, BEC occurs at very low temperatures, and thus P(δ,T)≈1, for any δ. In addition, as long as the dopant charge is mobile, there are 2-hole clusters (m=2) even for low average values of q. This is possible because when two one-hole clusters come within an interaction distance of each other, there will be a preferential formation of one 2-hole cluster because of the lower energy of the singlet state. Since most cuprates have mobile dopant charges at low q, we find for the threshold value, q₀=0.408 (c/a)/13 n. The situation for n-doped Nd₂. ₓCeₓCuO₄ (NCCO) is quite different in that the dopant electron is not mobile at very low q concentrations since NCCO is an insulator until q≈0.14. Thus it is expected that one-electron clusters will continue to exist up to q≈1/13 (0.077). When Eqn. (5) is modified to take this into account the result for NCCO is 2(q₀−0.077)=0.408 (c/a)/13 n.

Table I lists the calculated and experimental (measured or estimated) values of the threshold dopant value, q₀ for several representative cuprates. The lattice constants, a and c are for the primitive unit cell which contains only one formula unit and one Cu atom per layer, with n Cu—O layers in the cell. Experimental values of q₀ appear to exist only for LSCO and Y123 the others being estimates of ≈0.05. There is very good agreement between theoretical and experimental values. There is no experimental value or estimate of the q₀ for NCCO since this compound becomes an abrupt superconductor at the insulator-metal transition at q≈0.14. The theoretical value of 0.10 represents an effective threshold value.

TABLE I

| Cuprate | a (A) | c (A) | n | q₀(exp) | q₀(th) |
|---|---|---|---|---|---|
| La₂₋ₓSrₓCuO₄ | 3.78 | 6.60 | 1 | 0.056 | 0.055 |
| (LSCO) | | | | | |
| Nd₂₋ₓCeₓCuO₄ | 3.94 | 6.05 | 1 | — | ≈0.10 |
| (NCCO) | | | | | |
| YBa₂Cu₃O_{7-y} | 3.85 | 11.65 | 2 | 0.05 | 0.047 |
| (Y123) | | | | | |
| Bi₂Sr₂CaCu₂O_{8-y} | 3.9 | 15.4 | 2 | ≈0.05 | 0.062 |
| (Bi2212) | | | | | |
| Bi₂Sr₂Ca₂Cu₃O_{10-y} | 3.9 | 18.6 | 3 | ≈0.05 | 0.050 |
| (Bi2223) | | | | | |
| HgBa₂CaCu₂O_{7-y} | 3.9 | 12.7 | 2 | ≈0.05 | 0.051 |
| (Hg1212) | | | | | |
| HgBa₂Ca₂Cu₃O_{9-y} | 3.9 | 15.9 | 3 | ≈0.05 | 0.043 |

To obtain the full dependence of the transition temperature T_{c} on dopant charge per in-plane Cu, q, the values for the energy gap δ and its dependence on q must be determined. The energy gap, δ, is affected both by local crystal fields and by the Coulomb repulsion of local charges, and since both the dopant ion concentration (local fields) and the local charge are proportional to q, δ must itself be a function of q. Due to strong electron correlations and strong on-site Coulomb repulsion in the Cu—O planes, the probability for forming a stable bound preformed pair in the (Cu)₁₃ cluster decreases with increasing q. In the present embodiment this is equivalent to having δ decrease with q. At some higher value of q, the number of charges in the cluster is large enough that the strong Coulomb repulsion prevents the formation of stable bound preformed pairs. This is equivalent in the model to setting δ→0 since then the cluster energy manifold collapses and only non-bonding states are left. Thus, without resort to any fitting procedure, the physics of the model indicate that δ decreases with q and that, at some upper value of q, δ→0. From an analysis of experimental T_{c} vs q curves, it is determined that δ decreases linearly with q throughout the superconducting dopant range. Thus it is possible to calculate δ(q) from only two data points on a T_{c} vs q experimental curve.

For the cuprates, the T_{c} decreases and the superconductivity completely disappears in the overdoped region beyond which the material then behaves as a normal metal. This behavior is readily explained by the present model since, at some value of q, δ→0 because of strong Coulomb repulsion. In the present embodiment, the disappearance of superconductivity in the overdoped region occurs when δ→0, since at this point, all 13 cluster states become degenerate and non-bonding with the result that there can be no bounded bosonic quasiparticles at any temperature. In addition, since there are no longer any preformed pairs, the system will tend to behave as a conventional Fermi liquid metal. Thus the point on the T_{c} vs q curve in the overdoped region where T_{c}→0 can be identified as the one where δ→0 as well.

Table II lists the experimental and theoretical values for the maximum T_{c}, T_{c}^{m}, the dopant charge q at T_{c}^{m}, qₘ, and the calculated values of the energy gap δ at T_{c}^{m}, δₘ, for the representative cuprates. The theoretical T_{c}^{m}, qₘ, and energy gap, δₘ, are derived from the present model. The table also includes experimental, Δₘ(exp), and theoretical, Δₘ(th)=12δₘ, for the superconducting gap.

TABLE II

| | T_{c}^{m}(exp) | T_{c}^{m}(th) | | | δₘ | Δₘ(exp) | Δₘ(th) = 12δₘ |
|---|---|---|---|---|---|---|---|
| Cuprate | (K) | (K) | qₘ(exp) | qₘ(th) | (meV) | (meV) | (meV) |
| LSCO | 36 | 36 | ≈0.15 | 0.154 | 1.35 | (≈20 est.^{b}) | 16.2 |
| NCCO | 22 | 22 | 0.14-0.15 | ≈0.14 | 0.80 | (≈12 est.) | 9.6 |
| Y123 | 92 | 93 | ≈0.16 | ≈0.15 | 2.91 | ≈42 | 34.9 |
| Bi2212 | 95 | 96 | ≈0.16 | ≈0.15 | 4.22 | ≈40 | 50.6 |
| Bi2223 | 110 | 111 | ≈0.16 | ≈0.15 | 3.25 | ≈45 | 39.0 |
| Hg1212 | 127 | 128 | ≈0.16 | ≈0.15 | 4.39 | ≈52 | 52.7 |
| Hg1223 | 133 | 135 | ≈0.16 | ≈0.15 | 3.65 | (≈54 est.) | 43.8 |

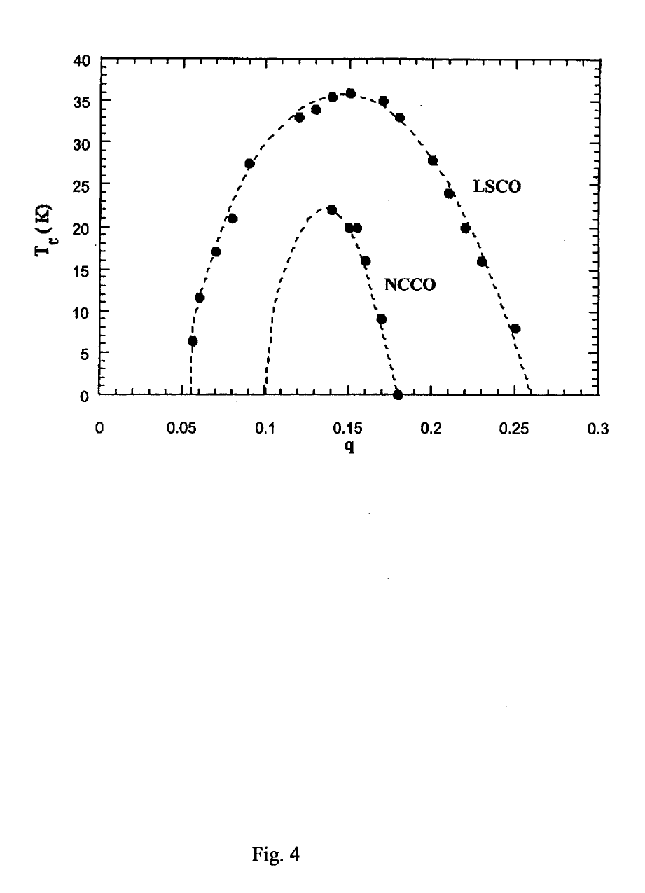

FIG. 4 illustrates the theoretical T_{c} vs q curves for both LSCO and NCCO together with experimental data. It is demonstrated that the theoretical qₘ for LSCO is =0.154 (2/13), which is in excellent agreement with the experimental value of 0.15. For NCCO, the theoretical curve, which peaks at q≈0.14, demonstrates why this material becomes abruptly superconducting at the insulator-metal transition. When the dopant charge becomes mobile at q≈0.14, the system suddenly finds itself with a boson density well in excess of the threshold value needed for BEC, since that threshold density is reached, according to the theory, at q≈0.10, and so the system abruptly goes superconducting with a T_{c} appropriate for the higher boson density, as indicated by the theoretical curve.

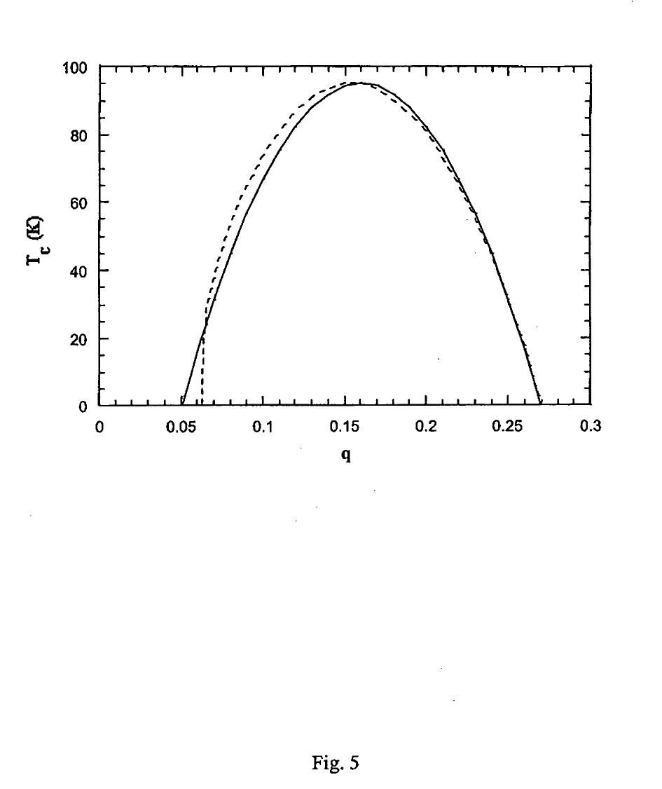

Most p-doped cuprates are assumed to have phase diagrams, and thus T_{c} vs q curves, similar to LSCO. Thus a generic empirical relationship is often used for most cuprates, with T_{c}/T_{c}^{m}=1−82.6(q−0.16)². FIG. 5 illustrates the T_{c} vs q curve obtained for Bi2212 from the (Cu)₁₃-BEC model together with the curve derived from the empirical expression. Of particular interest is the fact that the theoretical curve for Bi2212, and in fact for most cuprates, tends to peak at q≈0.154 (2/13) which is quite close to the empirical value of 0.16. This behavior is to be expected from the (Cu)₁₃-BEC model since a q of 2/13 represents the situation where all of the (Cu)₁₃ clusters have exactly two charges per Cu—O layer and thus one preformed pair and thus one superconducting pair at T→0. Since there can be only one preformed pair per layer in a single cluster, this value of q represents the maximum possible superfluid density or stiffniess at T→0. As q increases beyond 2/13, there can be no further increase in superfluid density at T→0, but there is a continuing decrease in 6 and thus in the superconducting pairing strength. Thus while T_{c} can increase with increasing q below q≈2/13, it tends to begin to decrease for q>2/13. The general observation that superconducting cuprates tend to have bell-shaped doping curves with maximum transition temperatures in the region of q≈0.15-0.16 is thus a natural consequence of the (Cu)₁₃-BEC model.

One concern is the sensitivity of the theoretical T_{c} vs q curve to the specific fitting protocol used to establish the 6 vs q curve and in particular whether the values of the key parameters, qₘ, δₘ and T_{c}^{m} are predetermined by the selection of q≈2/13 as one of the two fitting points. Table III presents a sensitivity analysis for both LSCO and Bi2212 using four different fitting protocols for each material. For LSCO the 6 vs q curve is obtained using for the two fitting points (q₁,q₂), (0.10, 0.26), (2/13, 0.26), (0.20, 0.26) and (0.10, 0.20). For Bi2212 the fitting points, (0.10, 0.27), (2/13, 0.27), (0.20, 0.27) and (0.10, 0.20) are used. Table m demonstrates that qₘ is especially robust for both materials, varying by less that 2% for the different fitting protocols, thus verifying that the T_{c} vs q curve is indeed bell-shaped with a peak at qₘ≈2/13. The T_{c}^{m} and δₘ are a bit more sensitive to the fitting protocol, although here again the variation in T_{c}^{m} and δₘ is <5% in LSCO, and is <6% in Bi2212.

TABLE III
LSCO

| (q₁, q₂) | (0.10, 0.26) | (2/13, 0.26) | (0.20, 0.26) | (0.10, 0.20) |
|---|---|---|---|---|
| qₘ | 0.148 | 0.150 | 0.150 | 0.149 |
| T_{c}^{m} (K) | 36 | 36 | 35.5 | 36 |
| δₘ (meV) | 1.44 | 1.41 | 1.41 | 1.42 |

Bi2212

| (q₁, q₂) | (0.10, 0.27) | (2/13, 0.27) | (0.20, 0.27) | (0.10, 0.20) |
|---|---|---|---|---|
| qₘ | 0.153 | 0.154 | 0.154 | 0.153 |
| T_{c}^{m} (K) | 90 | 95 | 96 | 92 |
| δₘ (meV) | 4.00 | 4.20 | 4.26 | 4.08 |

One of the major features of the superconducting cuprates is the fact that within a homologous series of cuprates, such as the 1-Tl, 2-Tl, 2-Bi and 1-Hg series of compounds, T_{c}^{m} tends to increase with the number, n, of Cu—O layers but then begins to saturate, or in some cases to decrease, with increasing n. This behavior is readily explained by the present model. The lattice constant, c, in the primitive cell changes as n increases within a given homologous series as, cₙ=c₁+(n−1)t where t is the distance between adjacent Cu—O planes. Substituting this expression for C in Eqn. (5), we have at optimal doping,

13qₘP(δₘ,T_{c}^{m})=0.408[{c₁+(n−1)t}/a]/n (7)

The right-hand side of Eqn. (7) decreases with increasing n. If both qₘ and δₘ remain constant, then this decrease of the right-hand side will result in a decrease in P(δₘ,T_{c}^{m}) and thus in an increase in T_{c}^{m}. However as n continues to increase the decrease in the right-hand side saturates toward a constant value of 0.408(t/a), and thus T_{c}^{m} will saturate toward a constant value as well. If, however, qₘ or δₘ decreases with increasing n, then T_{c}^{m} will reach a maximum level and then begin to decrease as n continues to increase. The dopant charge qₘ, averaged over the layers, can decrease as n increases because the inner layers may get less charge than the outer layers and the average δₘ can decrease because of increased Coulomb repulsion or correlation effects in the (CU)₁₃ cluster as the number of layers in the cluster increases.

The present model agrees very well with the threshold doping and the T_{c} vs q curves for the cuprates. The present model is also able to account, in a quantitative and natural way, for many other thermodynamic and electronic characteristics of the superconducting cuprates, including many of the key experimental ARPES, μSR and microwave results on the temperature and doping dependencies of both the superfluid density and the pairing strengths (superconducting gap, leading-edge-midpoint and psuedogap) in these high-temperature superconductors.

### Maximizing the Transition Temperature

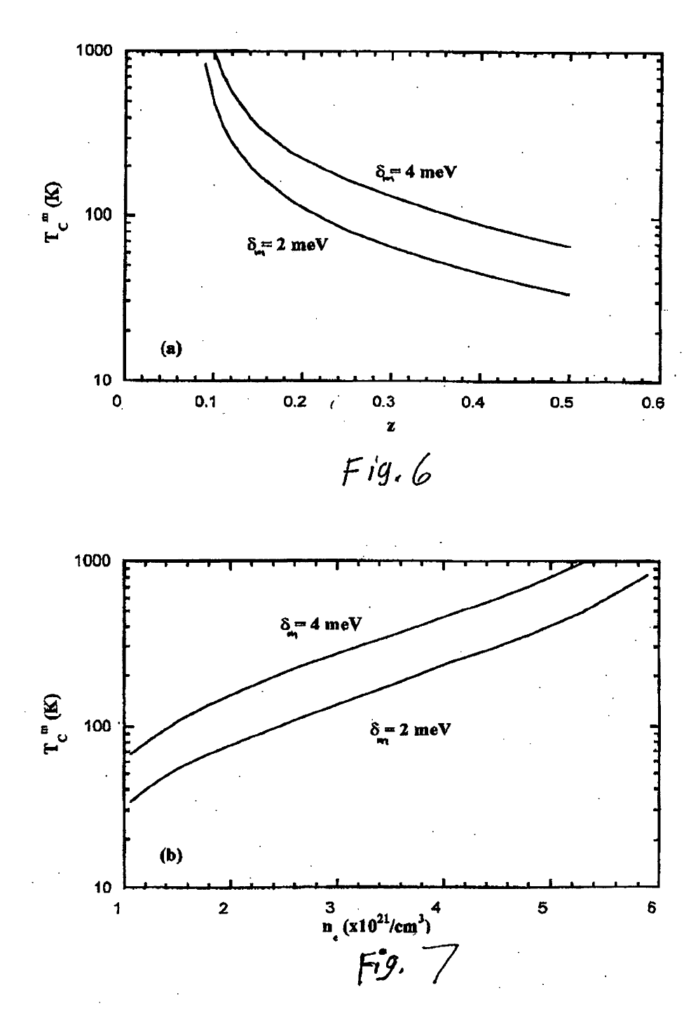

Defining the value z as P(δₘ,T_{c}^{m})=0.408(c/a)/(13 nqₘ), it can be seen that to maximize T_{c}^{m}, it is necessary to minimize the value of z and maximize the value of m. It can be seen in FIG. 6, where T_{c}^{m} is plotted as a function of z assuming two values of δₘ (2 and 4 meV), that a small value of z is important. For constant δₘ, T_{c}^{m} is a super-exponential function of decreasing z, increasing very rapidly for z less than 0.2. To reduce the value of z, one can decrease the ratio (c/a) and/or increase qₘ. Since it can be difficult to significantly alter lattice constants, and since qₘ is generally limited to ≈0.15 in the cuprates, the most dramatic change in z can come about from an increase in the charge density, through an increase in n, the number of Cu—O layers in a primitive unit cell. For example, at n=∞, z=0.408(t/a)/(13 qₘ), where the smaller interlayer distance t replaces the lattice constant c, and the charge density increases by a factor of 2-3×. Typical charge densities in n=1 and n=2 cuprates are 1-2×10²¹/cm³. The n=∞ cuprates have charge densities of about 4×10²¹/cm³, which is still more than an order of magnitude smaller than most metals. As an example, the Model predicts that a bismouth (Bi) cuprate compound that has a T_{c}^{m}≈95 K for n=2 will have a T_{c}^{m}>300 K for n=∞ as long as δₘ remains constant.

To further increase T_{c}^{m}, the value of m can be increased. The energy δₘ, which is the effective binding energy of the preformed pairs, is related to the strength of the interaction between Cu ions. The interaction is a combination of a charge site-hopping interaction and an antiferromagnetic superexchange interaction between the Cu sites. The strength of the superexchange interaction can determine the magnitude of the Neel temperature, T_{N}, of the antiferromagnetic insulating phase of the cuprate. Thus, δₘ should be proportional to the strengths of the site-hopping and superexchange interactions and to the magnitude of the Neel temperature T_{N}.

The Model indicates that superconductivity in the cuprates occurs when the thermal wavelength and the average distance between preformed pairs are both approximately equal to the interaction distance between the (CU)₁₃ clusters. The interaction distance is the cluster size, 4 a, plus 1.5 a for a total interaction distance of 5.5 a. It can be shown from the present model that the transition temperature will increase if the interaction distance increases. We can increase the interaction distance by increasing a and also by increasing the basic cluster size. Increasing a requires increasing the in-plane lattice constant. Increasing the size of the cluster implies the use of materials that have especially large interaction clusters that may include atoms beyond third-nearest neighbors.

### Non-Cuprate Superconductors

Although the present model was initially developed for the superconducting cuprates, the general concepts of the Model can be extended to other compounds, including non-layered systems. The present model allows for compunds with charge densities, n_{c}, higher than the cuprates to demonstrate BEC superconductivity. For non-cuprates Eqns. (1) and (3) can be used with n_{b}=½nₑ P(δₘ,T_{c}^{m}). If the interaction distance, d, in these materials is comparable to that found in the cuprates (≈20 A), or even greater, it is possible, as indicated by FIG. 7, that a T_{c}^{m} well in excess of 300 K can be achieved for charge densities only three to four times greater (4-8×10²¹ cm⁻³) than those already found in the cuprates. These densities are still an order of magnitude lower than most metals. Since conventional metals do not exhibit BEC superconductivity, but instead exhibit BCS superconductivity at much lower temperatures, it can be assumed that there is a transition from BEC to BCS superconductivity with increasing charge density. Some materials, such as other oxides, ceramics, poor metals, intermetallic compounds, doped insulators or semiconductors, with charge densities intermediate between the cuprates and typical metals, can exhibit BEC superconductivity at temperatures in excess of 300 K.

Characteristics of other materials that can exhibit high-temperature superconductivity using the Model can include covalent bonding, as well as the ability to form appropriate singlet states from orbital hybridization in clusters containing several atoms, with such singlet states forming preformed bosonic pairs that are spatially bounded and have low binding energies and a short-range attractive interaction with other preformed pairs. Other characteristics can include charge densities of at least 10²⁰ cm⁻³, and normal (non-superconducting) properties that indicate the existence of preformed charge pairs, such as a linear resistivity with temperature at low temperatures.

Those skilled in the art will recognize that the superconductors described herein can be used to replace existing materials in devices such as electric motors, electric generators, transmission lines, wires, cables, electromagnets, computers and computing devices, communication devices, telecommunication devices, active and passive components of analog circuits, active and passive components of digital circuits, microelectronic devices, logic switches, interconnection materials and devices, electronic filters, scientific instruments, magnetometers, medical systems, MRI devices, NMR devices, electro-optical devices, magneto-optical devices, lasers, and memory circuits.

Additionally, those skilled in the art will recognize how to use the superconductors discussed above to replace current materials in devices designed for generating electrical power, transmitting electrical power, conditioning electrical power, storing electrical energy, generating electrical signals, generating electromagnetic signals, transmitting electrical signals, transmitting electromagnetic signals, switching electrical power, switching electromagnetic signals, transporting or conveying people, and transporting or conveying goods or materials.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In the claims:

1. A high-temperature cuprate-type superconductor having a primary interaction cluster consisting of:
a central Cu atom;
four nearest Cu atoms;
four second-nearest Cu atoms; and
four third-nearest Cu atoms.

2. The high-temperature cuprate-type superconductor of claim 1, wherein:
the interaction between the central Cu atom and one of the third-nearest Cu atoms is comparable to the interaction between the central Cu atom and one of the nearest Cu atoms.

3. The high-temperature cuprate-type superconductor of claim 1, wherein:
a singlet state, formed from orbital hybridization in clusters containing several atoms, is spatially bounded to dimensions comparable to the size of the primary interaction cluster.

4. The high-temperature cuprate-type superconductor of claim 1, wherein the singlet state has a wavefunction symmetry given by dₓ²_{-y}².

5. The high-temperature cuprate-type superconductor of claim 1, wherein the singlet state remains spatially bounded and retains a sufficient amount of phase coherence so that the singlet state forms a bosonic preformed charge pair during transport through a lattice.

6. The high-temperature cuprate-type superconductor of claim 1, wherein the cuprate-type superconductor comprises preformed charge singlet pairs at T>T_{c}.

7. The high-temperature cuprate-type superconductor of claim 1, wherein the cuprate-type superconductor comprises preformed charge singlet pairs comprising bosons.

8. The high-temperature cuprate-type superconductor of claim 1, wherein the cuprate-type superconductor comprises preformed charge singlet pairs with low binding energies.

9. The high-temperature cuprate-type superconductor of claim 1, wherein the cuprate-type superconductor comprises preformed charge singlet pairs with binding energies of less than 100 meV.

10. The high-temperature cuprate-type superconductor of claim 1, wherein the cuprate-type superconductor comprises preformed charge singlet pairs that have a short-range attractive potential between pairs.

11. The high-temperature cuprate-type superconductor of claim 1, wherein the cuprate-type superconductor comprises an attractive interaction distance between preformed charge pairs of between about 5 A and about 100 A.

12. The high-temperature cuprate-type superconductor of claim 1, wherein the cuprate-type superconductor comprises an attractive interaction distance between preformed charge pairs of approximately 20 A.

13. The high-temperature cuprate-type superconductor of claim 1, wherein the cuprate-type superconductor comprises a charge pair comprised of two electrons.

14. The high-temperature cuprate-type superconductor of claim 1, wherein the cuprate-type superconductor comprises a charge pair comprised of two holes.

15. The high-temperature cuprate-type superconductor of claim 1, wherein the cuprate-type superconductor comprises bosonic preformed charge pairs that become superconducting in a Bose-Einstein condensation (BEC) type transition.

16. The high-temperature cuprate-type superconductor of claim 1 having charge densities greater than 1×10²⁰/cm³.

17. The high temperature cuprate-type superconductor of claim 1 having a singlet state, wherein a singlet state is formed from orbital hybridization in clusters containing several atoms.

18. A high-temperature cuprate-type superconductor which satisfies a basic condition for BEC given by:
13 qP(δ,T)=0.408(c/a)/n
and wherein:
q is the average dopant charge per Cu atom in the Cu—O layer in the cluster;
P(δ,T) is the probability that a charge is residing in the singlet state at temperature T;
δ is the energy gap between the singlet state and the next highest energy level, and the effective binding energy of the preformed charge pair;
c and a are the tetragonal lattice constants of a primitive unit cell; and
n is the number of layers in a primitive unit cell.

19. The high-temperature superconductor of claim 18 which satisfies a second basic condition for BEC given by 13 qP(δ,T)<?, which arises from the fact that there is only one singlet state per copper oxide layer in a cluster.

20. The high-temperature cuprate-type superconductor of claim 18, wherein a global superconducting transition occurs at a density of preformed pairs where the average distance between the pairs is approximately equal to the short-range attractive interaction distance.

21. The high-temperature cuprate-type superconductor of claim 18, comprising a cuprate-type material having a low z value, wherein z is given by:
z=0.408(c/a)/(13nqₘ)
and wherein:
qₘ is the dopant charge per Cu atom when the transition temperature T_{c} is at its maximum value as a function of doping.

22. The high-temperature cuprate-type superconductor of claim 21, wherein the cuprate-type material has a low z value through a combination of decreasing (c/a) and/or increasing qₘ.

23. The high-temperature cuprate-type superconductor of claim 21, wherein the cuprate-type material has a low z value through a decreasing (cla) and/or increasing qm.

24. The high-temperature cuprate-type superconductor of claim 21 having a high qₘ value.

25. The high-temperature cuprate-type superconductor of claim 21, wherein qₘ≧0.15.

26. The high-temperature cuprate-type superconductor of claim 21, wherein:
the cuprate-type material has a low z value through increasing the number n of (Cu—O) layers in a unit cell.

27. The high-temperature cuprate-type superconductor of claim 21, wherein:
the cuprate-type material has a low z value through increasing the charge density nₑ.

28. The high-temperature cuprate-type superconductor of claim 21, wherein the cuprate-type material has charge densities greater than 1×10²⁰/cm³.

29. The high-temperature cuprate-type superconductor of claim 21, wherein the cuprate-type material has a relatively high value of δₘ, where δₘ is the effective binding energy of the preformed charge pair when T_{c} is at its maximum value as a function of doping.

30. The high-temperature cuprate-type superconductor of claim 21, wherein the cuprate-type material has δₘ>1 meV.

31. The high-temperature cuprate-type superconductor of claim 21 having a relatively high site-hopping and/or superexchange interactions between the atoms in the cluster.

32. The high-temperature cuprate-type superconductor of claim 21 having a relatively high Neel temperature, TN, in the antiferromagnetic insulating phase.

33. The high-temperature cuprate-type superconductor of claim 21 having a Neel temperature T_{N}>500K in the antiferromagnetic insulating phase.

34. The high-temperature cuprate-type superconductor of claim 21 comprising a material that exhibits BEC superconductivity at temperatures higher than BCS type superconducting transitions.

35. The high-temperature cuprate-type superconductor of claim 21 comprising a material that exhibits BEC superconductivity at temperatures in excess of 300 K.

36. The high-temperature cuprate-type superconductor of claim 21, wherein the cuprate-type material has a low z value through increasing the size of the cluster by increasing the lattice constant a.

37. The high-temperature cuprate-type superconductor of claim 21, wherein the cuprate-type material has a low z value through increasing the size of the cluster by increasing the number of atoms participating in the cluster beyond the third nearest neighbors.

38. A high-temperature superconductor having a singlet state, wherein the singlet state is formed from orbital hybridization in interaction clusters containing several atoms.

39. The high-temperature superconductor of claim 38 having a singlet state that is spatially bounded to dimensions comparable to the size of the cluster.

40. The high-temperature superconductor of claim 38, having a singlet state that remains spatially bounded and retains a sufficient amount of phase coherence so that it forms a bosonic preformed charge pair during transport through the lattice.

41. A high-temperature superconductor having preformed charge singlet pairs at T>T_{c}.

42. The high temperature superconductor of claim 41, wherein the high-temperature superconductor comprises preformed charge singlet pairs that comprise bosons.

43. The high temperature superconductor of claim 41, wherein the high-temperature superconductor comprises preformed charge singlet pairs with low binding energies.

44. The high temperature superconductor of claim 41, wherein the high-temperature superconductor comprises preformed charge singlet pairs with binding energies of less than 100 meV.

45. The high temperature superconductor of claim 41, wherein the high-temperature superconductor comprises preformed charge singlet pairs that have a short-range attractive interaction between the pairs.

46. The high temperature superconductor of claim 41, wherein the high-temperature superconductor comprises an attractive interaction distance between preformed charge pairs of between about 5 A and about 10 A.

47. The high temperature superconductor of claim 41, wherein the high-temperature superconductor comprises a charge pair comprised of two electrons.

48. The high temperature superconductor of claim 41, wherein the high-temperature superconductor comprises a charge pair comprised of two holes.

49. The high temperature superconductor of claim 41, wherein the high-temperature superconductor comprises a charge pair comprised of one electron and one hole.

50. A high temperature superconductor wherein a global superconducting transition occurs at a density of preformed pairs where the average distance between the pairs is approximately equal to the attractive interaction distance.

51. The high-temperature superconductor of claim 50, where the boson density, n_{b}, is given by:
n_{b}=½nₑP(δ,T)
and wherein:
nₑ is the charge density;
P(δ,T) is the probability that a charge is residing in the singlet state at temperature T; and
δ is the energy gap between the singlet state and the next highest energy level, and the effective binding energy of the preformed charge pair.

52. The high-temperature superconductor of claim 51 having charge densities greater than 1×10²⁰/cm³.

53. The high-temperature superconductor of claim 51 having charge densities intermediate between the cuprates (1-2×10²¹/cm³) and conventional metals (10²²-10²³/cm³).

54. The high-temperature superconductor of claim 50 having a relatively large interaction cluster.

55. The high-temperature superconductor of claim 50 having a relatively large lattice constant.

56. The high-temperature superconductor of claim 50 having a lattice constant larger than 3 A.

57. The high temperature superconductor of claim 50, having relatively high interaction between the atoms in its cluster.

58. A device containing a high-temperature superconductor according to any of claims 1, 18, 38, 41, or 50.

59. The device of claim 58, wherein said device is capable of executing a function selected from the group consisting of: generating electrical power, transmitting electrical power, conditioning electrical power, storing electrical energy, generating electrical signals, generating electromagnetic signals, transmitting electrical signals, transmitting electromagnetic signals, switching electrical power, switching electromagnetic signals, transporting or conveying people, and transporting or conveying goods or materials.

60. The device of claim 58, wherein said device is selected from the group consisting of: electric motors, electric generators, transmission lines, wires, cables, electromagnets, computers and computing devices, communication devices, telecommunication devices, active and passive components of analog circuits, active and passive components of digital circuits, microelectronic devices, logic switches, interconnection materials and devices, electronic filters, and memory circuits.

61. The device of claim 58, wherein said device is selected from the group consisting of: scientific instruments, magnetometers, medical systems, MRI devices, NMR devices, electro-optical devices, magneto-optical devices, and lasers.

62. A method for making a high-temperature superconductor according to any of claims 1, 18, 38, 41, or 50.
